(19) United States
(12) Patent Application Publication
(10) Pub. No.: US 2010/0219772 A1
(43) Pub. Date: Sep. 2, 2010

(54) PORTABLE ELECTRONIC DEVICE

(75) Inventors: BIN ZHANG, Shenzhen City (CN); JUAN FENG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); CHI MEI COMMUNICATION SYSTEMS, INC., Tu-Cheng City (TW)

(21) Appl. No.: 12/579,788

(22) Filed: Oct. 15, 2009

(30) Foreign Application Priority Data
Feb. 27, 2009 (CN) 200910300601.3

(51) Int. Cl. H05B 37/02

(52) U.S. Cl. 315/297; 315/309

(57) ABSTRACT

A portable electronic device includes a housing, at least one thermoscope unit mounted on the housing, a processor unit connected to the thermscope unit, and at least one light emitting unit connected to the processor unit. The processor unit stores data of predetermined different light colors corresponding to different ambient temperature ranges. The thermoscope unit detects ambient temperature, the processor unit obtains the ambient temperature from the thermoscope unit and controls the light emitting unit to emit light in predetermined colors corresponding to the ambient temperature range according to the stored data.

### BACKGROUND

1. Technical Field

The present disclosure relates to portable electronic devices, and particularly to a portable electronic device capable of changing colors.

2. Description of Related Art

Portable electronic devices, such as mobile phones, personal digital assistants (PDA) and laptop computers, are widely used. Besides high quality and multiple functions, these portable electronic devices are often desired to have various appearances. Therefore, changeable housings and accessories (e.g., outside protective films) in various colors are often used in many portable electronic devices. Such changeable housings and accessories allow the user to selectively modify the appearances of the portable electronic devices. However, these housings and accessories may increase cost of the portable electronic devices, and frequent operations of changing the housings or accessories may damage the structures of the portable electronic devices.

Therefore, there is room for improvement within the art.

### BRIEF DESCRIPTION OF THE DRAWINGS

Many aspects of the present portable electronic device can be better understood with reference to the following drawings. The components in the various drawings are not necessarily drawn to scale, the emphasis instead being placed upon clearly illustrating the principles of the present portable electronic device. Moreover, in the drawings, like reference numerals designate corresponding parts throughout the figures.

FIG. 1 is a schematic view of a portable electronic device, according to an exemplary embodiment.

FIG. 2 is a block diagram of the portable electronic device shown in FIG. 1.

FIG. 3 is a cutaway view of a housing of the portable electronic device shown in FIG. 1.

### DETAILED DESCRIPTION

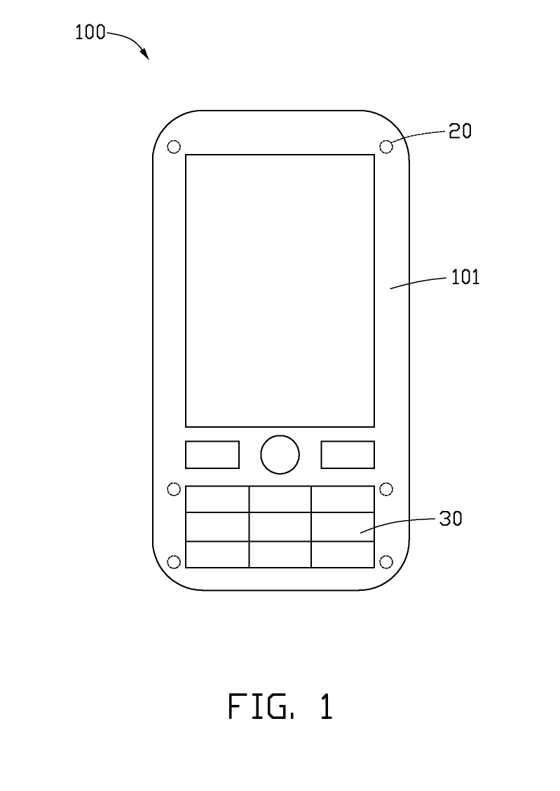

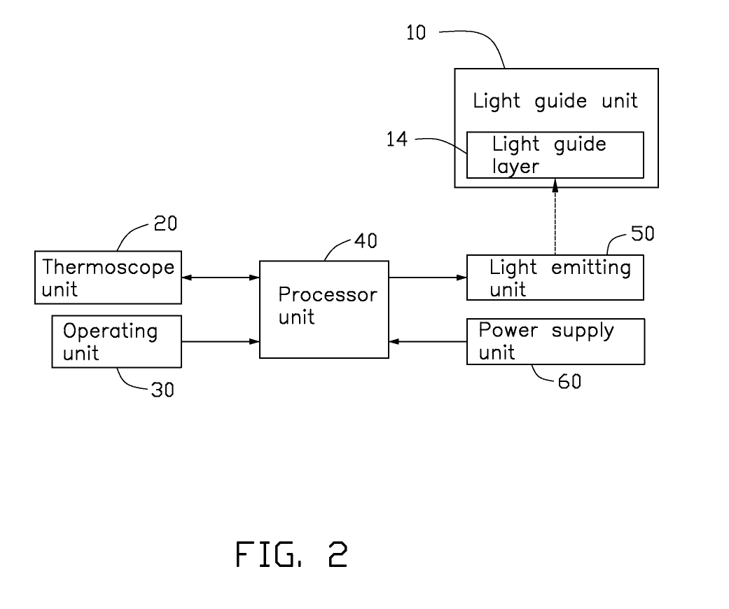

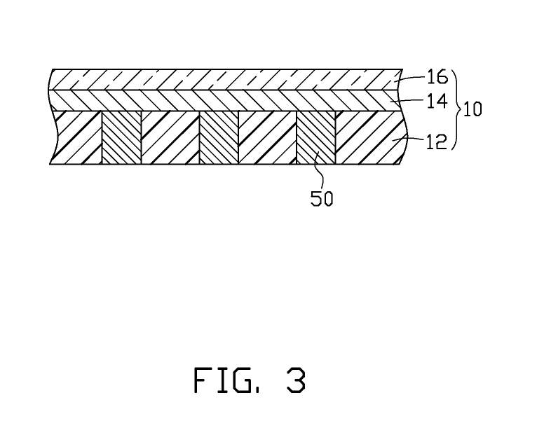

FIG. 1 schematically shows a portable electronic device 100 according to an exemplary embodiment. The portable electronic device 100 is a mobile phone, and can also be a personal digital assistant (PDA), a laptop computer, etc. The portable electronic device 100 includes a housing 101. Also referring to FIG. 2 and FIG. 3, the portable electronic device 100 includes a light guide unit 10, at least one thermoscope unit 20, an operating unit 30, a processor unit 40, at least one light emitting unit 50, and a power supply unit 60.

The light guide unit 10 includes a substrate 12, a light guide layer 14 and a protective transparent layer 16. The substrate 12 is made of rigid materials such as plastic or metal, and can be integrated with any portion of the housing 101. The light guide layer 14 is formed on the substrate 12, and the transparent layer 16 is formed on the light guide layer 14 and exposes out of the housing 101. The light guide layer 14 can be made of light guide plate, light guide film or fiber, etc. The transparent layer 16 can be made of glass, transparent plastics, etc.

The at least one thermoscope unit 20 can be installed on any part of the housing 101 (e.g., shown in FIG. 1, a plurality of thermoscope unit 20 installed on different parts of the housing 101) to detect ambient temperature. The operating unit 30 can be conventional input devices of the portable electronic device 100, such as the keypad and display. The processor unit 40 can be a central processing unit (CPU) of the portable electronic device 100 received in the housing 101. The at least one thermoscope unit 20 and the operating unit 30 are all electronically connected to the processor unit 40.

The at least one light emitting unit 50 can be a color-changeable light emitting diode (LED) array mounted on the housing 101. The at least one light emitting unit 50 is installed in the substrate 12, exposing out of the substrate 12 and covered by the light guide layer 14, and the light guide layer 14 is positioned in the emitting light path of the light emitting unit 50. When the light emitting unit 50 emits light, the light can be guided to the transparent layer 16 by the light guide layer 14, and then emitted from the transparent layer 16. The at least one light emitting unit 50 is electronically connected to the processor unit 40. The power supply unit 60 can be conventional power supplies (e.g., a battery) of the portable electronic device 100 received in the housing 101. The power supply unit 60 is electronically connected to the processor unit 40 and the light emitting unit 50 to provide working electric power.

The users of the portable electronic device 100 can first predetermine different colors of light emitted by the light emitting unit 50 corresponding to different temperature ranges by the operating unit 30 and the processor unit 40. For example, the light emitting unit 50 can be set to emit light in “cold colors” (e.g., blue or green) when ambient temperature is relatively high (e.g., 20° C.-30° C.), and emit light in “warm colors” (e.g., red or yellow) when ambient temperature is relatively low (e.g., 0° C.-10° C.). The data of predetermined different colors of light emitted by the light emitting unit 50 corresponding to different temperature ranges is stored in conventional storages of the portable electronic device 100 by the processor module 40, and can be checked and changed at any time via the operating module 30.

In use, the at least one thermoscope unit 20 automatically detects ambient temperatures and generates corresponding electronic signals. The processor unit 40 receives the electronic signals from the thermoscope unit 20 and obtains ambient temperature. The processor unit 40 then selects predetermined light colors according to the stored data, and controls the light emitting unit 50 to emit light in the selected colors. The light is guided to the transparent layer 16 by the light guide layer 14, and then emits from the transparent layer 16 to change the appearance of the portable electronic device 100. Furthermore, besides the transparent layer 16, the light guide layer 14 can also be used to guide the light to any predetermined area of the housing 101 to emit.

When the ambient temperature changes, the processor unit 40 determines the current temperature using the thermoscope unit 20, and then controls the light emitting unit 50 to emit light in colors corresponding to the current temperature. Thus, the color of the light emitted by the light emitting unit 50 can be automatically changed according to current ambient temperature, and the appearance of the portable electronic device 100 is changed. For example, the portable electronic device 100 can emit light in “cold colors” in a relative high temperature and emit light in “warm colors” in a relative low temperature to comfort the users thereof. Additionally, the users can also directly control the light emitting unit 50 to emit light in desired colors by the operating module 30 and the processor unit 40.

As above-mentioned, since the substrate 12 can be integrated with any portion of the housing 101, the light guide unit 10 can be formed on any portion of the housing 101. Thus, the color of any portion of the portable electronic device 100 can be automatically changed according to environment temperature, i.e., the portable electronic device 100 can achieve different appearances without using the changeable housings. Therefore, the portable electronic device 100 costs less, and is prevented from damage caused by operations of changing the housings for getting different appearances.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A portable electronic device, comprising:
a housing;
at least one thermoscope unit mounted on the housing for detecting the ambient temperature;
a processor unit connected to the thermscope unit, the processor unit storing data of predetermined different light colors corresponding to different ambient temperature ranges;
at least one light emitting unit connected to the processor unit; wherein the processor unit obtains the ambient temperature from the thermoscope unit and controls the light emitting unit to emit light in predetermined colors corresponding to the ambient temperature range according to the stored data.

2. The portable electronic device as claimed in claim 1, further comprising a light guide unit formed on the housing to guide the light emitted by the light emitting unit out of the housing.

3. The portable electronic device as claimed in claim 2, wherein the light guide unit includes a substrate integrated with the housing and a light guide layer formed on the substrate and positioned in the emitting light path of the light emitting unit.

4. The portable electronic device as claimed in claim 3, wherein the light emitting unit is installed in the substrate and exposes out of the substrate.

5. The portable electronic device as claimed in claim 3, wherein the light emitting unit is a color-changeable light emitting diode (LED) array.

6. The portable electronic device as claimed in claim 3, wherein the light guide unit further comprises a transparent layer formed on the light guide layer and exposes out of the housing.

7. The portable electronic device as claimed in claim 6, wherein light emitted by the light emitting layer is guided by the light guide layer to the transparent layer and emits from the transparent layer.

8. A portable electronic device, comprising:
a housing;
a thermoscope for determining the ambient temperature;
at least one color-changeable light emitting unit mounted on the housing, the colors of light emitted by the light emitting unit changeable in response to changes in the detected ambient temperature; and
a light guide unit formed on the housing, the light guide unit including a substrate integrated with the housing and a light guide layer formed on the substrate and positioned in the emitting light path of the light emitting unit, wherein the light guide layer guides the light emitted by the light emitting unit out of predetermined area of the housing to be emitted.

9. The portable electronic device as claimed in claim 8, wherein the light emitting unit is a color-changeable light emitting diode (LED) array.

10. The portable electronic device as claimed in claim 8, further comprising a processor unit connected to the light emitting unit and for controlling the light emitting unit to emit light in predetermined colors.

11. The portable electronic device as claimed in claim 8, wherein the light guide unit further comprises a transparent layer formed on the light guide layer and exposes out of the housing.
